(19) United States
(12) Patent Application Publication
(10) Pub. No.: US 2011/0025276 A1
(43) Pub. Date: Feb. 3, 2011

(54) CHARGE CONTROL CIRCUIT

(75) Inventors: HSING-YUAN HSIEH, Shindian (TW); JING ZHANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/756,309

(22) Filed: Apr. 8, 2010

(30) Foreign Application Priority Data
Jul. 28, 2009 (CN) 200910304910.8

(51) Int. Cl. H02J 7/00

(52) U.S. Cl. 320/148; 320/163

(57) ABSTRACT

A charge control circuit used to control a battery to charge includes a power management unit, a voltage converting unit, a voltage comparison unit, and a switch control unit. The power management unit supplies a voltage to the battery. The voltage converting unit provides a reference voltage to the voltage comparison unit. The voltage comparison unit compares a battery voltage obtained from the battery with the reference voltage, and sends a comparison to the switch control unit. The switch control unit controls the power management unit to charge or stop charging the battery according to the comparison.

### BACKGROUND

1.Technical Field

The disclosure generally relates to charge control circuits, particularly to a charge control circuit used to control the charging of a battery of a portable electronic device.

2. Description of Related Art

The portable electronic device such as a mobile phone has been playing an important role in the rapidly developed technological fields. Users place more reliance on mobile phones than ever, since mobile phone enables a user to keep contact with others at any place and at any time. A mobile phone commonly obtains power from a rechargeable battery such as a lithium ion (Li+) battery.

The rechargeable battery needs to be recharged using an adapter after discharging its stored electrical power to the mobile phone, and can be fully recharged when the voltage of the battery equals a stable voltage. For example, the stable voltage of a Li+ battery is about 4.2V. However, if the adapter remains connected to the battery after voltage stabilization, the adapter may consume the stored power of the battery and damage the battery by overcharging.

Therefore, there is room for improvement within the art.

### BRIEF DESCRIPTION OF THE DRAWINGS

Many aspects of the charge control circuit can be better understood with reference to the following drawings. The components in the drawings are not necessarily drawn to scale, the emphasis instead being placed upon clearly illustrating the principles of the charge control circuit.

FIG. 1 is a block diagram of a charge control circuit, according to an exemplary embodiment.

FIG. 2 is a circuit diagram of the charge control circuit of FIG. 1.

### DETAILED DESCRIPTION

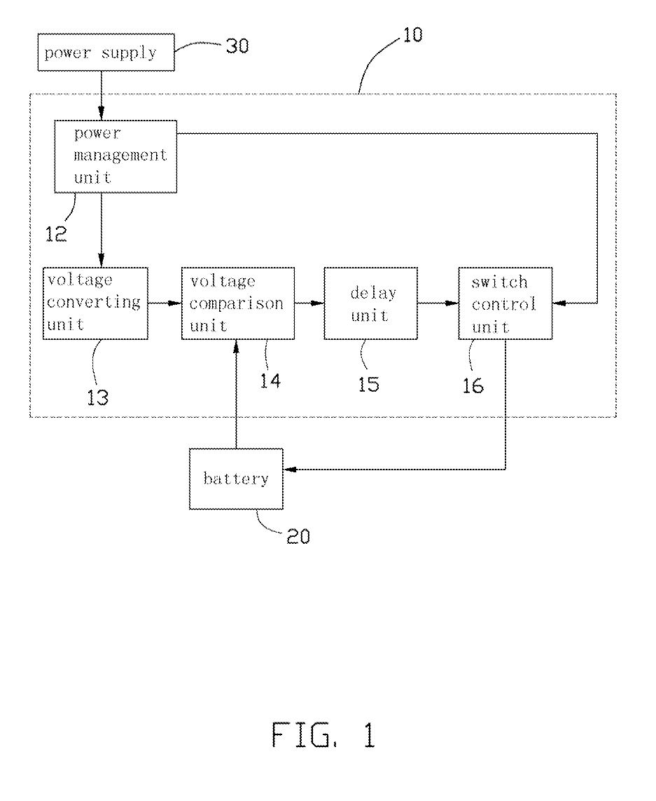

Referring to FIG. 1, a charge control circuit 10 used to control charging of a battery 20 of a portable electronic device such as a mobile phone, according to one exemplary embodiment, includes a power management unit 12, a voltage converting unit 13, a voltage comparison unit 14, a delay unit 15 and a switch control unit 16. The power management unit 12, the voltage converting unit 13, the voltage comparison unit 14, the delay unit 15 and the switch control unit 16 are connected in series, and also the power management unit 12 is connected to the switch control unit 16.

The power management unit 12 is configured to connect to a power supply 30. The power supply 30 supplies a voltage VIN to the power management unit 12. The power management unit 12 converts the voltage VIN to a voltage VI and a voltage VC, supplying to the voltage converting unit 13 and the battery 20, respectively.

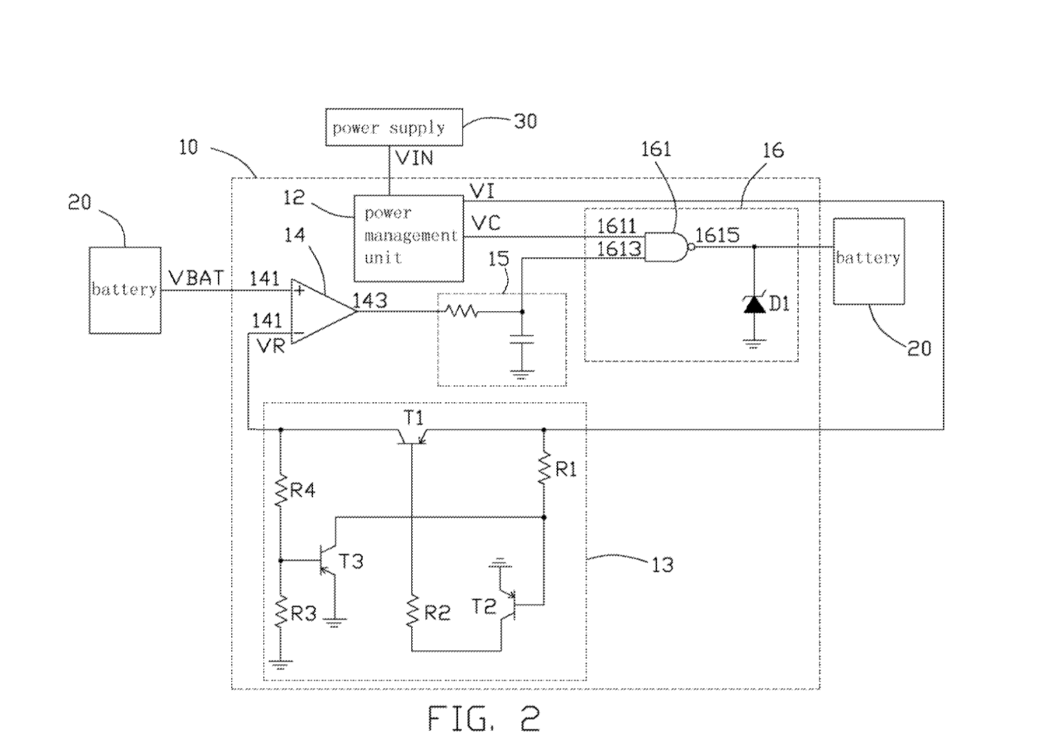

The voltage converting unit 13 obtains the voltage VIN supplied by the power management unit 12 and provides a reference voltage VR to the voltage comparison unit 143 according to the voltage YIN. Referring to FIG. 2, in this embodiment, the voltage converting unit 13 includes a first transistor T1, a second transistor T2, a third transistor T3, a first resistor R1, a second resistor R2, a third resistor R3, and a fourth resistor R4. The first, and second transistors T1, T2 are pnp bipolar transistors, and the third transistor T3 is an npn bipolar transistor.

The emitter of the first transistor T1 is connected to the power management unit 12 and obtains the voltage VI. The collector of the first transistor T1 is connected to the voltage comparison unit 14. The base of the first transistor T1 is connected to the collector of the second transistor T2 through the second resistor R2. The base of the second transistor T2 is connected to the emitter of the first transistor T1 through the first resistor R1. The emitter of the second transistor T2 and the emitter of the third transistor T3 are connected to ground. The collector of the third transistor T3 is connected to the base of the second transistor T2. One end of the third resistor R3 is connected to ground and the other end of the third resistor R3 is connected to the base of the third transistor T3 and the input contact 141 through the fourth resistor R4. The reference voltage VR provided by the voltage converting unit 13 can be adjusted by changing the resistance values of the third resistor R3 and the fourth resistor R4.

The voltage comparison unit 14 is configured to connect to the battery 20, and obtain a battery voltage VBAT from the battery 20. The voltage comparison unit 14 compares the battery voltage VBAT with the reference voltage VR provided by the voltage converting unit 13, and outputs a corresponding comparison result to the switch control unit 16 through the delay unit 15. In this embodiment, the voltage comparison unit 14 includes two input contacts 141 and an output contact 143. The two input contacts 141 are respectively connected to the battery 20 and the voltage converting unit 13 to obtain the battery voltage VBAT and the reference voltage VR. The output contact 143 is connected to the switch control unit 16 through the delay unit 15 to output the comparison result. For instance, when the battery voltage VBAT is lower than the reference voltage VR, the output contact 143 outputs a low level voltage such as less than 5V as the comparison result. When the battery voltage VBAT equals the reference voltage VR, the output contact 143 outputs a high level voltage such as 5V as the comparison result.

The delay unit 15 receives the comparison result from the voltage comparison unit 14 and sends the comparison result to the switch control unit 16 after a delay. The delay unit 15 is a resistor-capacitor (RC) circuit.

The switch control unit 16 control the power management unit 12 to charge or stop charging the battery 20 according to the comparison result received from the delay unit 15. In this embodiment, the switch control unit 16 includes a NAND member 161 and a diode D1. The NAND member 16 includes two input contacts 1611, 1613, and an output contact 1615. One input contact 1611 is connected to the power management unit 12 to obtain the voltage VC as a high level voltage. Another input contact 1613 is connected to the delay unit 15 to obtain the comparison result from the delay unit 15. The output contact 1615 is connected to the battery 20 and outputs a high level voltage such as 5V or a low level voltage such as less than 5V to control the power management unit 12 to charge or stop charging the battery 20. The cathode of the diode D1 is connected to the output contact 1615. The node of the diode D1 is connected to ground. The diode D1 stabilizes the voltage output from the output contact 1615.

When charging the battery 20, when the battery voltage VBAT is lower than the reference voltage, the voltage comparison unit 14 outputs a low level voltage to the input contact 1611, in addition, the power management unit 12 outputs the voltage VC as a high level voltage to the input contact 1163. The output contact 1165 outputs a high level voltage such as 5V to the battery 20, and the battery 20 is still charged by the power management unit 12. When the battery voltage VBAT equals the reference voltage, the voltage comparison unit 14 outputs a high level voltage to the input contact 1611 after the delay. In addition, the power management unit 12 outputs the voltage VC as a high level voltage such as 5V to input contact 1163. The output contact 1165 outputs a low level voltage such as less than 5V to the battery 20, and the power management unit 12 stops charging the battery 20 after the delay.

The charge control unit 10 compares the battery voltage of the battery 20 with the reference voltage using the voltage comparison unit 14, and controls the power management unit 12 to stop charging the battery 20 when the battery voltage of the battery 20 equals the reference voltage to reduce electrical energy consumptions and avoid overcharging.

It is believed that the exemplary embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A charge control circuit used to control a battery to charge; comprising:
a power management unit supplying a voltage to the battery;
a voltage converting unit;
a voltage comparison unit; and
a switch control unit; wherein the voltage converting unit provides a reference voltage to the voltage comparison unit; the voltage comparison unit compares a battery voltage obtained from the battery with the reference voltage, and sends a comparison result to the switch control unit; the switch control unit controls the power management unit to charge or stop charging the battery according to the comparison result.

2. The charge control circuit as claimed in claim 1, wherein the switch control unit includes a NAND member, the NAND member includes two input contacts and an output contact, one input contact of the NAND member is connected to the power management unit to obtain the voltage as a high level, the other input contact of the NAND member is connected to the comparison unit to obtain the comparison result, the output contact of the NAND member outputs a high/low level voltage to control the power management unit to charge or stop charging the battery.

3. The charge control circuit as claimed in claim 2, wherein the switch control unit further includes a diode, the cathode of the diode is connected to the output contact, the node of the diode is connected to ground.

4. The charge control circuit as claimed in claim 1, wherein when the battery voltage is less than the reference voltage, the switch control unit controls the power management unit to charge the battery, when the battery voltage equals the reference voltage, the switch control unit controls the power management unit to stop charging the battery.

5. The charge control circuit as claimed in claim 1, wherein the voltage converting unit includes a first transistor, a second transistor, a third transistor, a first resistor, a second resistor, a third resistor and a fourth resistor; the emitter of the first transistor is connected to the power management unit, the collector of the first transistor is connected to the voltage comparison unit, the base of the first transistor is connected to the collector of the second transistor through the second resistor; the base of the second transistor is connected to the emitter of the first transistor through the first resistor, the emitter of the second transistor is connected to ground; the emitter of the third transistor is connected to ground, the collector of the third transistor is connected to the base of the second transistor; one end of the third resistor is connected to ground, another end of the third resistor is connected to the base of the third transistor and the voltage comparison unit through the fourth resistor.

6. The charge control circuit as claimed in claim 1, wherein when the battery voltage is lower than the reference voltage, the voltage comparison unit outputs a low voltage as the comparison; when the battery voltage equals the reference voltage, the voltage comparison unit outputs a high voltage as the comparison result.

7. The charge control circuit as claimed in claim 1, further including a delay unit set between the voltage comparison unit and the switch control unit, wherein the delay unit sends the comparison result from the voltage comparison unit to the switch control unit after a delay.

8. The charge control circuit as claimed in claim 7, wherein the delay unit is a RC circuit.
